(19) United States
(12) Patent Application Publication
(10) Pub. No.: US 2024/0383161 A1
(43) Pub. Date: Nov. 21, 2024

(54) KNIFE WITH LOCK AND RELEASE

(71) Applicant: TECHTRONIC CORDLESS GP, Anderson, SC (US)

(72) Inventors: Ben Ren Zhu, Dongguan City (CN); Trevor C. Fauss, Greenville, SC (US)

(21) Appl. No.: 18/784,648

(22) Filed: Jul. 25, 2024

Related U.S. Application Data
(63) Continuation-in-part of application No. PCT/CN22/75303, filed on Feb. 1, 2022.

(51) Int. Cl. B26B 1/04; B26B 5/00

(52) U.S. Cl. CPC B26B 1/044; B26B 5/00

(57) ABSTRACT

A knife including a handle having a first scale coupled to a second scale cooperatively defining a pocket and a slot, a blade assembly pivotably coupled to the handle, and a lock and release mechanism. The lock and release mechanism is at least partially disposed in the pocket and is defined by a monolithic element. The lock and release mechanism includes a base portion and a resilient portion extending from the base portion. The base portion is coupled to the handle and the resilient portion is movable between a static position and a depressed position relative to the base portion to vary the blade assembly between a closed position and an opened position.

### CROSS-REFERENCE TO RELATED APPLICATIONS

This application is a continuation-in-part of International Patent Application No. PCT/CN2022/075303, filed Feb. 1, 2022, the entire contents of which is incorporated herein by reference.

### BACKGROUND

The present disclosure relates to knives, and more particularly to folding knives having a monolithic, or single-piece, compression lock and release.

### SUMMARY

In some aspects, the invention provides a knife including a handle that has a first scale coupled to a second scale cooperatively defining a pocket and a slot, a blade assembly pivotably coupled to the handle, and a lock and release mechanism. The lock and release mechanism is at least partially disposed in the pocket and is defined by a monolithic element. The lock and release mechanism includes a base portion and a resilient portion extending from the base portion. The base portion is coupled to the handle and the resilient portion is movable between a static position and a depressed position relative to the base portion to vary the blade assembly between a closed position and an opened position.

In some aspects, the knife includes a handle with a first scale coupled to a second scale. The first scale and the second scale define a pocket and a slot therebetween. The knife also includes a blade assembly that is pivotably coupled to the handle and that defines a depression, and a lock and release mechanism that is at least partially disposed in the pocket. The lock and release mechanism is defined by a monolithic element and has a base portion coupled to the handle and a resilient portion extending from the base portion. The resilient portion has a detent protruding from the resilient portion and engageable with the depression when the blade assembly is in the closed position. The resilient portion movable between a static position and a depressed position relative to the base portion to vary the blade assembly between a closed position and an opened position.

In some aspects, the techniques described herein relate to a knife, wherein the resilient portion extends laterally relative to the base portion when the resilient portion is in the static position, and wherein the resilient portion is substantially co-planar with the base portion when the resilient portion is in the depressed position.

In some aspects, the techniques described herein relate to a knife, wherein the resilient portion is engaged with the blade assembly in the opened position to hold the blade assembly in the opened position, and wherein the resilient portion is engageable with the blade assembly in the closed position to hold the blade assembly in the closed position.

In some aspects, the techniques described herein relate to a knife, wherein the lock and release mechanism further includes a detent protruding from the resilient portion, the detent engageable with a depression defined in the blade assembly when the blade assembly is in the closed position.

In some aspects, the techniques described herein relate to a knife, wherein the blade assembly includes a front collet face coupled to a rear collet face and defining a cavity therebetween, and a blade removably disposed in the cavity.

In some aspects, the techniques described herein relate to a knife, further including a key disposed in the blade assembly and including biased retaining features engageable with blade recesses to fix a blade in the blade assembly.

In some aspects, the techniques described herein relate to a knife, wherein when the blade assembly is in the opened position, the resilient portion is movable toward the depressed position along an angled surface of the blade holder.

In some aspects, the techniques described herein relate to a knife including: a handle including a first scale coupled to a second scale, the first scale and the second scale defining a pocket and a slot therebetween; a blade assembly pivotably coupled to the handle and defining a depression; and a lock and release mechanism at least partially disposed in the pocket, the lock and release mechanism at least partially defined by a flexible element and including a base portion coupled to the handle and a resilient portion extending from the base portion and having a detent protruding from the resilient portion and engageable with the depression when the blade assembly is in the closed position, the resilient portion movable between a static position and a depressed position relative to the base portion to vary the blade assembly between a closed position and an opened position.

In some aspects, the techniques described herein relate to a knife, wherein the blade assembly includes a blade holder having the depression and a recess, and wherein the resilient portion is engaged with the blade assembly within the recess to hold the blade assembly in the opened position.

In some aspects, the techniques described herein relate to a knife, wherein the resilient portion extends laterally relative to the base portion when the resilient portion is in the static position, and wherein the resilient portion is substantially co-planar with the base portion when the resilient portion is in the depressed position.

In some aspects, the techniques described herein relate to a knife, wherein the lock and release mechanism includes a bridge connecting the base portion and the resilient portion, and wherein the resilient portion is flexible relative to the base portion about the bridge.

In some aspects, the techniques described herein relate to a knife, wherein the blade assembly includes a front collet face coupled to a rear collet face and defining a cavity therebetween, and a blade removably disposed in the cavity.

In some aspects, the techniques described herein relate to a knife, further including a key disposed in the blade assembly and including a biased retaining feature engageable with a blade recess to fix a blade in the blade assembly.

In some aspects, the techniques described herein relate to a knife, wherein the blade assembly includes a blade holder, and wherein the biased retaining feature includes an angled surface movable by insertion of the blade into the blade holder.

In some aspects, the techniques described herein relate to a knife, wherein when the blade assembly is in the opened position, the resilient portion is movable toward the depressed position along an angled surface of the blade holder.

In some aspects, the techniques described herein relate to a knife including: a handle including a first scale coupled to a second scale, the first scale and the second scale defining a pocket and a slot therebetween; a blade assembly pivotably coupled to the handle and defining a depression; and a lock and release mechanism at least partially disposed in the pocket, the lock and release mechanism including: a base portion coupled to the handle, the base portion having a first flexibility, and a resilient portion coupled to the base portion and having a detent protruding from the resilient portion and engageable with the depression when the blade assembly is in the closed position, the resilient portion having a second flexibility greater than the first flexibility, and wherein the resilient portion is bendable between a static position and a depressed position relative to the base portion to vary the blade assembly from an opened position to a closed position.

In some aspects, the techniques described herein relate to a knife, wherein when the blade assembly is in the closed position, the blade assembly is movable to the opened position without actuating the resilient portion.

In some aspects, the techniques described herein relate to a knife, wherein the second scale includes a carve-out configured to receive the resilient portion such that the resilient portion is nested within the second scale.

In some aspects, the techniques described herein relate to a knife, wherein in the opened position the resilient portion extends laterally from the second scale into the pocket.

In some aspects, the techniques described herein relate to a knife, wherein the resilient portion extends laterally relative to the base portion when the resilient portion is in the static position, and wherein the resilient portion is substantially co-planar with the base portion when the resilient portion is in the depressed position.

Other aspects of the invention will become apparent by consideration of the detailed description, the claims, and accompanying drawings. The drawings illustrate exemplary embodiments of the technology and, together with the description, serve to explain the principles of the technology.

### BRIEF DESCRIPTION OF THE DRAWINGS

FIG. 1 is a perspective view illustrating a utility knife including a body including a blade holder, a handle having a first scale and a second scale opposite the first scale, and a lock and release mechanism according to the present invention.

FIG. 2 is a schematic top view of the utility knife of FIG. 1.

FIG. 3A is a perspective view of the lock and release mechanism of the utility knife of FIG. 1.

FIG. 3B is another perspective view of the lock and release mechanism of the utility knife of FIG. 1.

FIG. 3C is another perspective view of the lock and release mechanism of the utility knife of FIG. 1.

FIG. 3D is another perspective view of the lock and release mechanism of the utility knife of FIG. 1.

FIG. 4A is a perspective view of a portion of the utility knife of FIG. 1 illustrating the blade holder locked in an opened position.

FIG. 4B is a section view of the utility knife of FIG. 1 with the blade holder in a locked, opened position.

FIG. 4C is a section perspective view of the utility knife of FIG. 1 with the blade holder in an unlocked, opened position.

FIG. 4D is a perspective view of a portion of the utility knife of FIG. 1 with the blade holder in an locked, opened position.

FIG. 5A is a perspective view of the utility knife of FIG. 1 with the blade holder in a closed or non-use position.

FIG. 5B is a perspective view of the utility knife of FIG. 4 with the first scale removed to illustrate the blade holder in a closed position.

FIG. 6 is a front end view of the utility knife of FIG. 1.

FIG. 7 is a perspective view of a portion of the blade holder of the utility knife of FIG. 1.

FIG. 8 is a perspective view of another utility knife including a lock and release mechanism with separate base and resilient portions.

FIG. 9A is a top view of the utility knife of FIG. 8.

FIG. 9B is a top view of a portion of the utility knife of FIG. 8 illustrating the lock and release mechanism.

FIG. 10 is an exploded view of the utility knife of FIG. 8.

FIG. 11A is a perspective view of the lock and release mechanism of the utility knife of FIG. 8.

FIG. 11B is a side view of the lock and release mechanism of the utility knife of FIG. 8.

FIG. 12 is a perspective view of the utility knife of FIG. 8 with the first scale removed to illustrate the blade holder held in the opened position by the lock and release mechanism.

FIG. 13 is a perspective view of the utility knife of FIG. 8 with the first scale removed to illustrate the blade holder in the closed position.

### DETAILED DESCRIPTION

Before any embodiments of the invention are explained in detail, it is to be understood that the invention is not limited in its application to the details of construction and the arrangement of components set forth in the following description or illustrated in the drawings. The invention is capable of other embodiments and of being practiced or of being carried out in various ways.

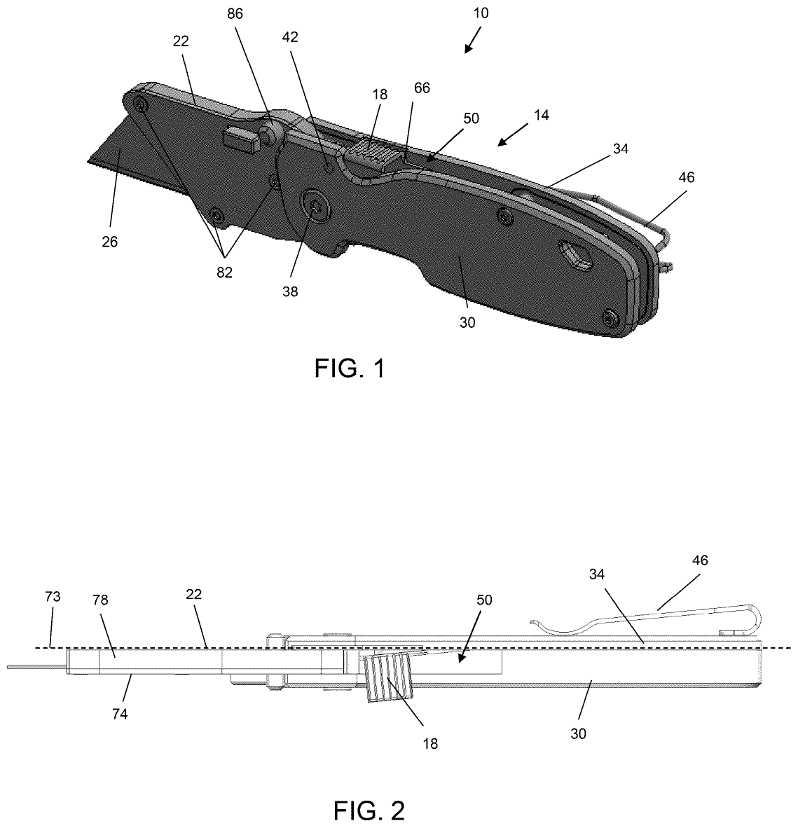

Also, it is to be understood that the phraseology and terminology used herein is for the purpose of description and should not be regarded as limiting. For example, while the embodiment shown in FIG. 1 discloses a utility knife, the invention also includes application of the disclosed technology to pocket and other types of folding knifes (e.g., those with a fixed or non-removable blade).

Any implementation described herein as “exemplary” is not necessarily to be construed as preferred or advantageous over other implementations. It will be apparent to those skilled in the art that modifications and variations can be made in the present technology without departing from the scope or spirit of the claimed technology.

The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, (e.g., clockwise or counterclockwise).

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

FIG. 1 illustrates an exemplary utility knife 10 including a handle 14, a lock and release mechanism 18, and a blade holder 22 that supports a blade 26. The handle 14 is contoured to provide a comfortable grip for the utility knife 10, and includes a first scale 30 and a second scale 34 that are coupled together by a fastener 38 (e.g., a rivet, bolt, etc.) that defines a pivot for the blade holder 22, and optionally also by a fastener or pin 42. A clip 46 may be coupled to the second scale 34 to support the utility knife 10 on a belt or other structure. As shown in FIGS. 1 and 2, the first scale 30 and second scale 34 cooperatively define a pocket 50 that is opened at the top between the first scale 30 and the second scale 34.

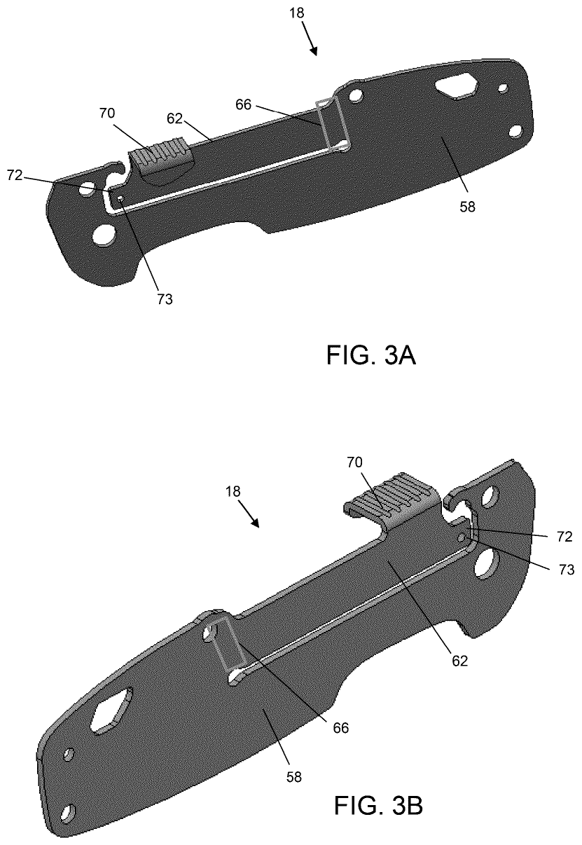

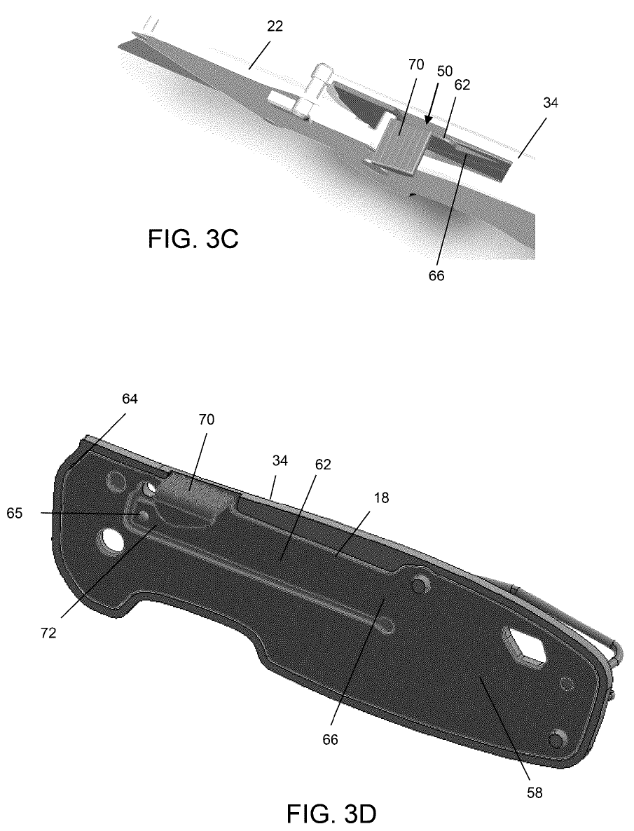

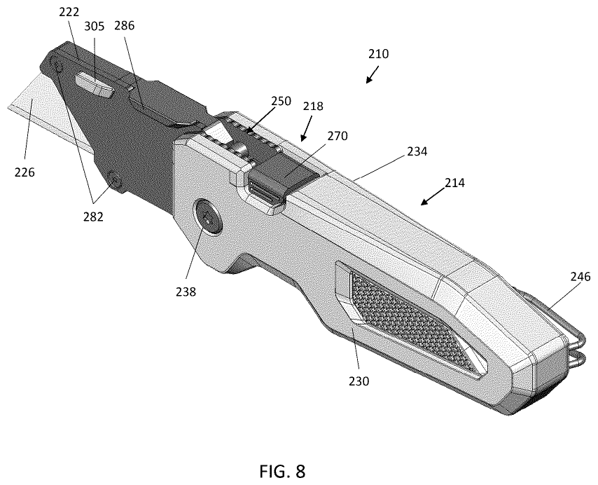

The lock and release mechanism 18 is at least partially disposed in the pocket 50. As shown in FIGS. 1, 3A-3D, and 5A, the lock and release mechanism 18 cooperates with the second scale 34 to hold the blade holder 22 in a closed position and an opened position. The lock and release mechanism 18 includes a base portion 58 and a resilient portion 62 that extends from the base portion 58. FIGS. 1 and 3D shows that the base portion 58 is coupled to the second scale 34 (e.g., via the fastener 38 and a pin 42). The base portion 58 defines a compression lock that holds the blade holder 22 in the opened position and the closed position. The illustrated second scale 34 has a carve-out 64 so that the base portion 58 may be received and nested in the second scale 34. With reference to FIG. 8, the second scale 34 also includes a detent 65 (e.g., having a hemispherical shape) that extends inward into the pocket 50. In some examples, the detent 65 may be disposed on the first scale 30. It will be appreciated that there may be one or more detents 65 on the first scale 30 or the second scale 34, or one or more detents 65 on each of the first scale 30 and the second scale 34. The illustrated resilient portion 62 is defined by a stamped cutout from the base portion 58 and has a flexible bridge 66 that connects to the base portion 58 adjacent an upper side of the lock and release mechanism 18 (as viewed in FIG. 3A). That is, the base portion 58 and the resilient portion 62 define a monolithic or single-piece compression lock and release mechanism 18.

With reference to FIGS. 1, 2, and 3A-3D, a button 70 is connected to the flexible bridge 66 and extends upward through the opening to the pocket 50, and a nose portion 72 is disposed on a distal end of the flexible bridge 66. The nose portion includes a hole 73 through which the detent 65 protrudes. The button 70 is formed as part of the same monolithic piece (e.g., steel) as the entirety of the lock and release mechanism 18. That is, the button 70 is integrated with the lock and release mechanism 18 and is resiliently movable to move the base portion 58 to lock and unlock the blade holder 22. With reference to FIG. 2, the flexible bridge 66 extends out of plane relative to the base portion 58 (i.e. relative to a plane 73 extending along the length of the base portion 58) such that the button 70 is laterally positioned relative to the base portion 58 and can be depressed by a user to permit movement of the blade holder 22 between an opened position and a closed position. It will be appreciated that the button 70 (and the resilient portion 62 more generally) also is biased laterally outward from the base portion 58 due to the angular nature of the flexible bridge 66 relative to the plane 73 extending along the base portion 58.

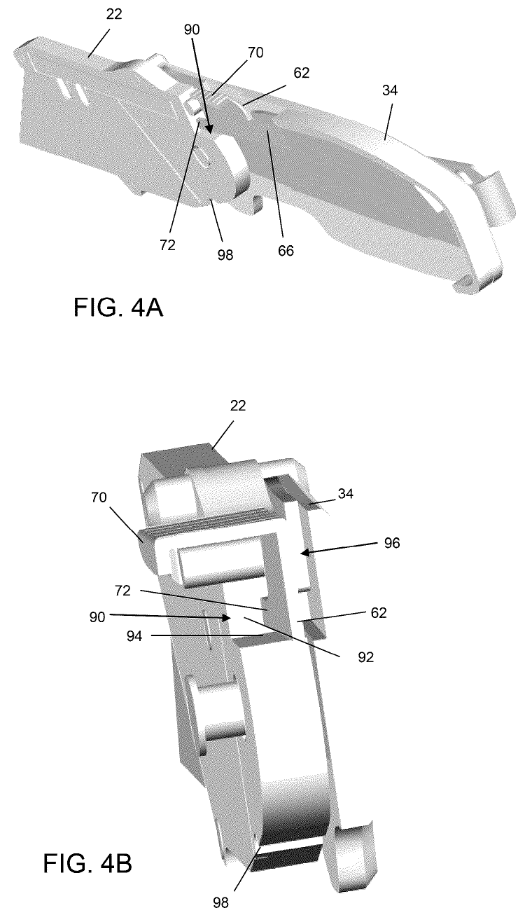

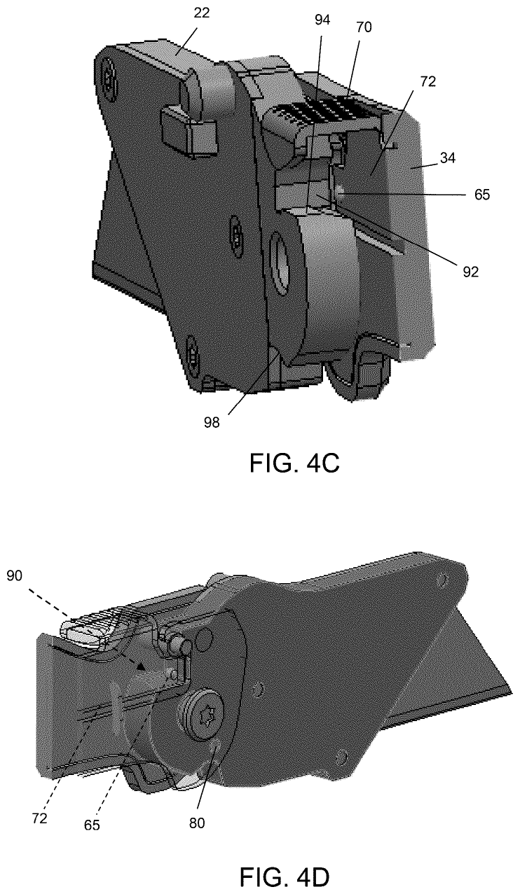

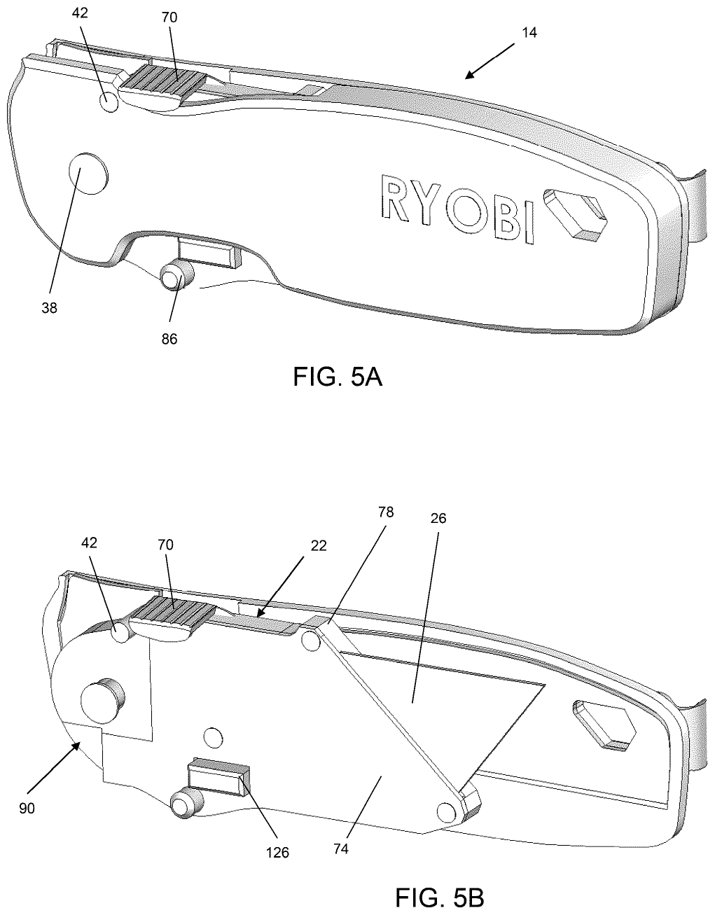

With reference to FIGS. 1 and 2, the blade holder 22 includes a front collet face 74 and a rear collet face 78 that may be coupled together by a plurality of fasteners 82 (e.g., press-fit pins, rivets, etc.). A thumb stud 86 may additionally couple the front collet face 74 to the rear collet face 78. The thumb stud 86 extends beyond lateral extents of the front collet face 74 and rear collet face 78 and is adjacent to and may abut the handle 14 when the blade holder 22 is in the opened position. Referring to FIGS. 4A-5B, the rear collet face 78 includes a recess 90 that is defined by a first engagement surface 92 and a second engagement surface 94. As shown, the second engagement surface 94 includes a ramp or angled portion 95 along which the resilient portion 62 may more easily slide or move toward the base portion 58 to allow movement of the blade holder 22 from the closed position or to the closed position. With reference to FIG. 4D, the rear collet face 78 has a depression or recess 80 (e.g., defining a nest for the detent 65) adjacent the fastener 38. In the closed position, the lock and release mechanism 18 biases the detent 65 into the recess 80 due to the spring-like bias of the resilient portion 62 relative to the base portion 58. When the blade holder 22 is in the unlocked, opened position, as shown in FIGS. 4A and 4B, the resilient portion 62 of the lock and release mechanism 18, and more particularly the nose portion 72, is disposed in the recess 90 and engageable with the first engagement surface 92 and the second engagement surface 94. The first engagement surface 92 is engageable with or by the nose portion 72 to minimize or inhibit over-rotation of the blade holder 22, and the second engagement surface 94 is engageable with or by the resilient portion 62 to hold the blade holder 22 in the opened position. The spacing between the first and second engagement recesses and the resilient portion 62 is minimized in the opened position to limit or prevent ‘play’ between the blade holder 22 and the handle 14. In the opened position, a void 96 is defined between the resilient portion 62 and the second scale 34. The lateral depth of the void 96 generally corresponds to the distance that the resilient portion 62, and the button 70, is laterally offset from the base portion 58.

With reference to FIG. 4C, the blade holder 22 is in the unlocked, opened position (i.e. prior to the blade holder 22 being moved to the closed position). As illustrated, the nose portion 72 has been removed from the recess 90 by lateral actuation of the button 70 toward the second scale 34, which allows the blade holder 22 to be pivoted to the closed position. In some embodiments, the blade holder 22 includes a notch 98 that is located below the recess 90 (when viewed from the perspective of FIG. 4A) to engage the fastener 38 when the blade holder 22 is in the closed position. When the blade holder 22 is in the closed position, the pin 42 may be captured in the notch 98 to hold the blade holder 22 in the closed position absent a force on the button 70. The pin 42 may also serve as a rotational stop for blade 26 and/or blade holder 22. The pin 42 may prevent the lock and release mechanism 18 from being overcome or subverted when the knife 10 is opened by compressing resilient portion 62 between the blade holder 22 and the pin 42.

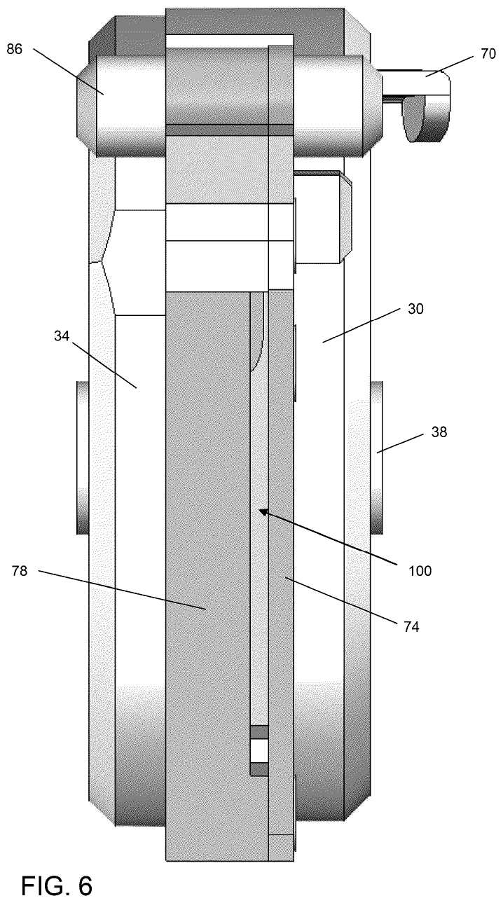

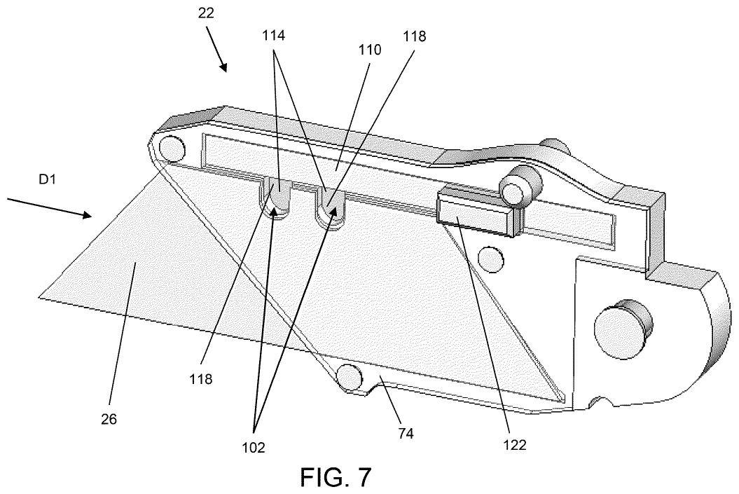

As shown in FIG. 6, the front collet face 74 and rear collet face 78 define a cavity 100. With reference to FIGS. 1 and 7, a blade 26 is partially disposed in the cavity 100 and is removably coupled to the blade holder 22. As illustrated, the blade 26 may be a typical utility knife blade that has alignment recesses 102 on an upper edge of the blade 26 to align the blade 26 in the cavity 100. With further reference to FIG. 7, the blade holder 22 includes a key 110 that is coupled to the blade holder 22 and that is in communication with the cavity 100. The key 110 includes retaining features 114 that are biased to extend from the key 110 toward the alignment recesses 102 to secure the blade 26 in the cavity 100. Each of the retaining features 114 includes an angled surface 118 that defines a ramp from an opening to the cavity 100 toward a rear of the blade holder 22 such that the blade 26 is configured to push the retaining features 114 against their bias to facilitate insertion and attachment of the blade 26 along an insertion direction D1. After the alignment recesses 102 are aligned with the retaining features 114, the retaining features 114 rebound to engage and hold the blade 26. The blade 26 is insertable into the blade holder 22 in an insertion direction D1. The key 110 may be moved cooperatively by the blade 26 and a user, or only by a user, via a boss 122. The boss 122 can be released to lock the blade 26 in the blade holder 22, and the boss 122 can be depressed to disengage the retaining features 114 from the blade 26, thereby facilitating removal of the blade 26.

The detent 65 engages the blade holder 22 within the recess 80 due to the lateral bias on the resilient portion 62 relative to the base portion 58 to hold the blade holder 22 in the closed position. In the illustrated embodiment, the pin 42 is engaged with the notch 98 to further hold the blade holder in the closed position. It will be appreciated that either of the detent-nest feature or the pin-notch feature may be provided, with or without the other feature, to hold the blade holder 22 in the closed position.

To move the blade holder 22 from the closed position to the opened position, a user presses the button 70 to disengage the pin 42 from the notch 98. Pressing the button 70 (e.g., laterally toward the second scale 34) also removes the detent 65 from the recess 80 in the blade holder 22, which allows the blade holder 22 to be flipped opened with a wrist motion by the user. Pressing the button 70 to opened the knife 10 is only necessary if a user desires to flip the blade holder 22 open. Separately, the blade holder 22 may be moved to the opened position by pulling on the blade holder 22 to overcome the force of the lock and release mechanism 18 pushing the detent 65 into the recess 80. Absent a force on the button 70, the lock and release mechanism 18 is in a static state that keeps the blade holder 22 in the closed position. After the blade holder 22 had been rotated or pivoted to the opened position, the blade 26 may be used to cut various materials. To close the blade holder 22, a user pushes the button 70 laterally in a direction generally intersecting the plane 73 and toward the second scale 34 (e.g., along the angled portion 95) so that the resilient portion 62 aligns with the void 96 (and is generally co-planar with the base portion 58), which allows the rear end of the blade holder 22 to clear the lock and release mechanism 18 and rotate or pivot to the closed position where the pin 42 re-engages the notch 98 and the detent 65 is biased into the recess 80.

While the embodiment shown in FIGS. 1-7 depicts a folding utility knife, it is to be understood that other types of knives could include the other features described in this disclosure as well, such as a pocket knife or other knife having a fixed (e.g., non-removable) blade. In such fixed knife embodiments, the blade 26 and blade holder 22 may, for example, be replaced by a fixed blade assembly (that may simply be a blade) that may otherwise operate and interact the same with the lock and release mechanism 18, and scales 30, 34, as described herein and as adapted as necessary to accommodate the fixed blade assembly.

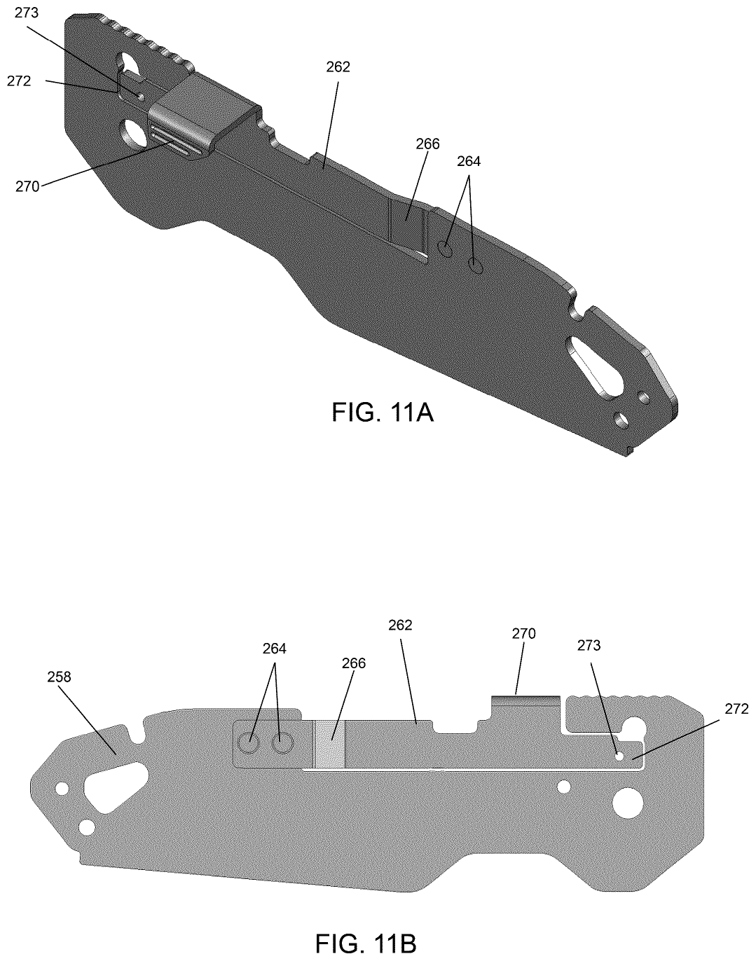

FIGS. 8-12 illustrate another utility knife 210 according to the disclosure. Except as described below, the utility knife 210 includes the same structure as the utility knife 10, and like elements are described with the same reference numerals plus “200”.

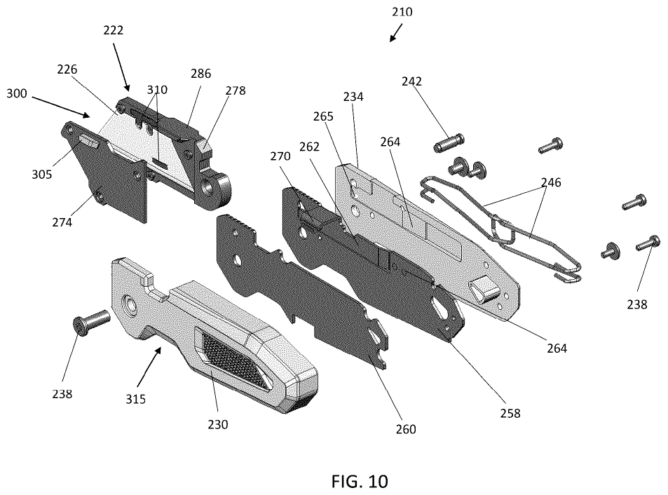

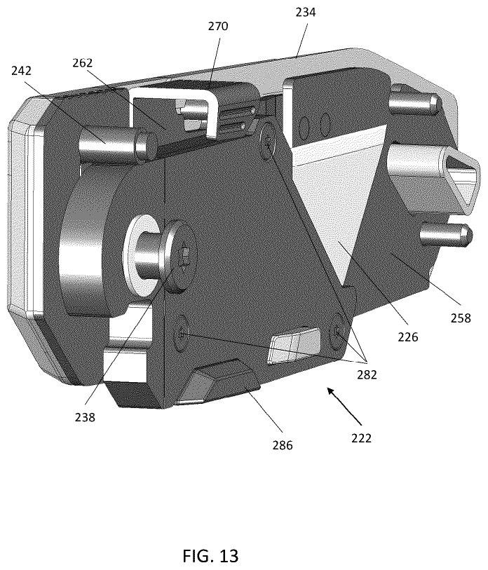

With reference to FIGS. 8-10, the utility knife 210 includes a handle 214, a lock and release mechanism 218, and a blade holder 222 that supports a blade 226. The handle 214 includes a first scale 230 and a second scale 234 that are coupled together by a fastener 238 and define a pocket 250 therebetween. A clip 246 may be coupled to the second scale 234 to support the utility knife 10 on a belt or other structure. As best shown in FIG. 10, the clip 246 may be reversible on the handle 214. The blade holder 222 is movable between an opened position (FIG. 8) and a closed position (FIG. 13).

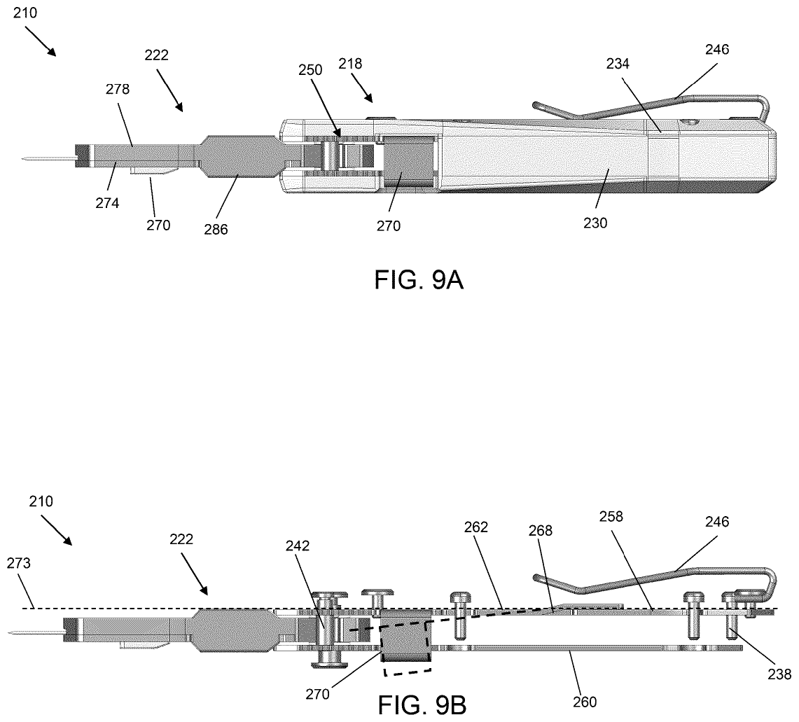

FIGS. 9B and 10 show that the utility knife 210 includes a first base portion 258 and a second base portion 260 disposed between the first scale 230 and the second scale 234. The utility knife 210 has a resilient portion 262 that is separate from and attached to the first base portion 258 by a fastener 264. The illustrated second scale 234 has a carve-out 264 so that the resilient portion 262 may be received and nested in the second scale 234. While the illustrated fastener 264 takes the form of one or more rivets (e.g., two rivets are shown in FIG. 10), it will be appreciated that the fastener 264 may take another form (e.g., welded, bolted, press-fit etc.) to secure the resilient portion 262 to the first base portion 258. The second scale 234 has a carve-out 264 so that the resilient portion 262 may be received and nested in the second scale 234. The illustrated base portions 258, 260 and the resilient portion 262 are stamped sheet metal. The resilient portion 262 may be more flexible than the base portions and accordingly may be a different material (e.g., a low-carbon steel), thickness, made using a different forming method (e.g., rolling) or have been heat treated using different processes (e.g., annealing) to allow for the flexibility of the resilient portion 262 to be greater than that of the first base portion 258. The first base portion 258 and the second base portion 260 are coupled to each other by a stop pin 242 configured to restrict the range of motion of the blade holder 222.

With reference to FIGS. 9B, 10, 11A, and 11B, the resilient portion 262 includes a flexible bridge 266, a button portion 270, and a nose portion 272 that has a hole 273 into which a detent 265 extends. As shown in FIG. 9B, the resilient portion 262 is biased laterally from the first base portion 258 due to the angular nature of the flexible bridge 266. The first base portion 258 may include a taper 268 at the interface between the first base portion 258 and the flexible bridge 266. The taper 268 may limit or restrict movement of the resilient portion 262 in the lateral direction toward the second base portion 260 beyond the desired bias for the resilient portion 262. It will be appreciated that reducing the range of motion of the resilient portion 262 prevents or largely reduces the cyclic fatiguing of the resilient portion 262. The resilient portion 262 extends out of plane relative to the base portion 258 (i.e. relative to a plane 273 extending along the length of the base portion 258) such that the button 270 is laterally positioned relative to the base portion 258 and can be depressed by a user to permit movement of the blade holder 222 between an opened position and a closed position. It will be appreciated that the button 270 (and the resilient portion 262 more generally) also is biased laterally outward from the base portion 258 due to the angular nature of the flexible bridge 66 relative to the plane 273. It will be appreciated that in the static position, the resilient portion 262 extends from within the second scale 234 to the pocket 250. In the static position of the resilient portion 262, the button portion 270 is operable by the user to urge the resilient portion 262 toward the first base portion 258 into a depressed position so that the blade holder can be retracted.

With reference to FIG. 10, the blade holder 222 includes a front collet 274 and a rear collet 278 coupled together by a plurality of fasteners 282 and defining a cavity 300 therebetween that receives the blade 226. The rear collet 278 includes a flange 286 extending laterally from the blade holder 222 to aide in manipulation of the blade holder 222. The flange 286 extends beyond the lateral extends of the front collet 274 and the rear collet 278 and may be received within a recess 315 of the handle 214 when the blade holder 222 is in the closed position. The blade holder 222 includes a release button 305 configured to actuate a key 310 coupled to the blade holder 222. The key 310 is couplable with the blade 226 and biased to move into the cavity 300 to restrict the motion of the blade 226. Upon actuating the release button 305, the key 310 is moved away from the cavity 300, thereby allowing removal or insertion of the blade 226.

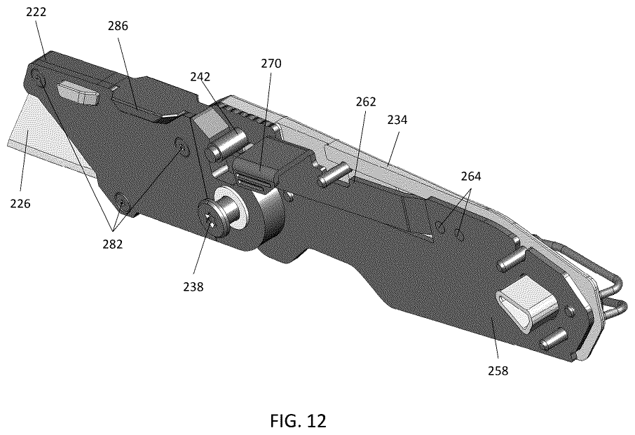

As shown in FIG. 12, when the blade holder 222 is in the opened position and the resilient portion 262 is in the static position, the blade holder 222 is fixed in place by the stop pin 242 and the nose portion 272. In some embodiments, the nose portion 272 of the resilient portion 262 may pinch against a surface of the blade holder 222 to further secure the blade holder 222 in place. During operation, to move the blade holder 222 from the opened position, a user urges the resilient portion 262 towards the depressed position, thereby disengaging the resilient portion 262 from the blade holder 222 and allowing the blade holder 222 to move towards the closed position.

As shown in FIG. 13, when the blade holder 222 is in the closed position, the resilient portion 262 is pressed toward the depressed position and the blade holder 222 is held in place by the detent 265 and the stop pin 242. The blade holder 222 is movable from the closed position to the opened position by overcoming the force of the detent 265. It will be appreciated that when the blade holder 222 is in the closed position, the blade holder 222 is movable to the opened position without actuating the resilient portion 262.

Various features of the disclosure are set forth in the following claims.

1. A knife comprising:
a handle including a first scale coupled to a second scale, the first scale and the second scale defining a pocket and a slot therebetween;
a blade assembly pivotably coupled to the handle; and
a lock and release mechanism at least partially disposed in the pocket, the lock and release mechanism defined by a monolithic element and including a base portion and a resilient portion extending from the base portion, the base portion coupled to the handle and the resilient portion movable between a static position and a depressed position relative to the base portion to vary the blade assembly between a closed position and an opened position.

2. The knife of claim 1, wherein the resilient portion extends laterally relative to the base portion when the resilient portion is in the static position, and wherein the resilient portion is substantially co-planar with the base portion when the resilient portion is in the depressed position.

3. The knife of claim 1, wherein the resilient portion is engaged with the blade assembly in the opened position to hold the blade assembly in the opened position, and wherein the resilient portion is engageable with the blade assembly in the closed position to hold the blade assembly in the closed position.

4. The knife of claim 3, wherein the lock and release mechanism further comprises a detent protruding from the resilient portion, the detent engageable with a depression defined in the blade assembly when the blade assembly is in the closed position.

5. The knife of claim 1, wherein the blade assembly includes a front collet face coupled to a rear collet face and defining a cavity therebetween, and a blade removably disposed in the cavity.

6. The knife of claim 1, further comprising a key disposed in the blade assembly and including biased retaining features engageable with blade recesses to fix a blade in the blade assembly.

7. The knife of claim 1, wherein when the blade assembly is in the opened position, the resilient portion is movable toward the depressed position along an angled surface of a blade holder.

8. A knife comprising:
a handle including a first scale coupled to a second scale, the first scale and the second scale defining a pocket and a slot therebetween;
a blade assembly pivotably coupled to the handle and defining a depression; and
a lock and release mechanism at least partially disposed in the pocket, the lock and release mechanism at least partially defined by a flexible element and including a base portion coupled to the handle and a resilient portion extending from the base portion and having a detent protruding from the resilient portion and engageable with the depression when the blade assembly is in a closed position, the resilient portion movable between a static position and a depressed position relative to the base portion to vary the blade assembly between a closed position and an opened position.

9. The knife of claim 8, wherein the blade assembly includes a blade holder having the depression and a recess, and wherein the resilient portion is engaged with the blade assembly within the recess to hold the blade assembly in the opened position.

10. The knife of claim 8, wherein the resilient portion extends laterally relative to the base portion when the resilient portion is in the static position, and wherein the resilient portion is substantially co-planar with the base portion when the resilient portion is in the depressed position.

11. The knife of claim 8, wherein the lock and release mechanism includes a bridge connecting the base portion and the resilient portion, and wherein the resilient portion is flexible relative to the base portion about the bridge.

12. The knife of claim 8, wherein the blade assembly includes a front collet face coupled to a rear collet face and defining a cavity therebetween, and a blade removably disposed in the cavity.

13. The knife of claim 8, further comprising a key disposed in the blade assembly and including a biased retaining feature engageable with a blade recess to fix a blade in the blade assembly.

14. The knife of claim 13, wherein the blade assembly includes a blade holder, and wherein the biased retaining feature includes an angled surface movable by insertion of the blade into the blade holder.

15. The knife of claim 14, wherein when the blade assembly is in the opened position, the resilient portion is movable toward the depressed position along an angled surface of the blade holder.

16. A knife comprising:
a handle including a first scale coupled to a second scale, the first scale and the second scale defining a pocket and a slot therebetween;
a blade assembly pivotably coupled to the handle and defining a depression; and
a lock and release mechanism at least partially disposed in the pocket, the lock and release mechanism including:
a base portion coupled to the handle, the base portion having a first flexibility, and
a resilient portion coupled to the base portion and having a detent protruding from the resilient portion and engageable with the depression when the blade assembly is in a closed position, the resilient portion having a second flexibility greater than the first flexibility, and wherein the resilient portion is bendable between a static position and a depressed position relative to the base portion to vary the blade assembly from an opened position to a closed position.

17. The knife of claim 16, wherein when the blade assembly is in the closed position, the blade assembly is movable to the opened position without actuating the resilient portion.

18. The knife of claim 16, wherein the second scale includes a carve-out configured to receive the resilient portion such that the resilient portion is nested within the second scale.

19. The knife of claim 18, wherein in the opened position the resilient portion extends laterally from the second scale into the pocket.

20. The knife of claim 16, wherein the resilient portion extends laterally relative to the base portion when the resilient portion is in the static position, and wherein the resilient portion is substantially co-planar with the base portion when the resilient portion is in the depressed position.
